(19) United States
(12) Patent Application Publication
(10) Pub. No.: US 2017/0353124 A1
(43) Pub. Date: Dec. 7, 2017

(54) DIGITAL POWER SUPPLY SYSTEM

(71) Applicant: Lighting Science Group Corporation, Cocoa Beach, FL (US)

(72) Inventors: Matthew Regan, Melbourne, FL (US); David Shonts, Satellite Beach, FL (US); Mark Andrew Oostdyk, Cape Canaveral, FL (US); Ran Zhou, Rockledge, FL (US); Theodore Scone, Satellite Beach, FL (US)

(73) Assignee: Lighting Science Group Corporation, Cocoa Beach, FL (US)

(21) Appl. No.: 15/609,654

(22) Filed: May 31, 2017

Related U.S. Application Data
(60) Provisional application No. 62/344,086, filed on Jun. 1, 2016.

(51) Int. Cl. H02M 7/217; H02M 1/08; H05B 33/08; H02M 3/158; H02M 1/00; G06F 1/32

(52) U.S. Cl. CPC H02M 7/217; H05B 33/0815; H02M 3/1582; H02M 1/08; G06F 1/3243; H02M 2001/0009

(57) ABSTRACT

A digital power supply system including a microcontroller, a driver, a step down circuit, and a buck and boost circuit is disclosed. The microcontroller circuit provides a first and second plurality of pulse width modulated signals and receives signals indicative of an input current, input voltage, output current, output voltage, and a 3.3 volt supply. The driver receives the first plurality of pulse width modulated signals and a 12 volt supply and provides a DC power signal and the signal indicative of the output current. The step down circuit receives a positive input voltage and provides the 3.3 volt supply. The boost circuit receives the 3.3 volt supply and provides the 12 volt supply. The buck and boost circuit receives the second plurality of pulse width modulated signals and provide the signals indicative of the output voltage, the input current, the input voltage, and the positive input voltage.

### RELATED APPLICATIONS

This application claims the benefit under 35 U.S.C. §119(e) of U.S. Provisional Patent Application Ser. No. 62/344,086 filed Jun. 1, 2016 (Attorney Docket 612.00348), the entire contents of which are incorporated herein by reference.

### FIELD OF THE INVENTION

The present invention relates to systems for regulating power supplies. More specifically, the present invention is directed to a digitally regulated power supply system, which regulates AC power, converts AC power to DC power, and provides DC power to a load.

### BACKGROUND

In an LED power supply device whose conducting current is a few tens of milliamperes, current applied is controlled by connecting a resistor in series with the LED. However, as LED brightness is required to be higher so that the conducting current is a few hundreds of milliamperes, heat released and power consumed by the resistor are make the use of a simple resistor in series with an LED impractical. In addition, since resistor size is larger, and design for heat releasing on a substrate side is required, constraints on design in portions other than the power supply circuit of the LED are encountered.

Such resistor constraints can be overcome by using a switching power supply circuit. Feedback voltage from an LED may be compared with a reference voltage from a reference voltage generation circuit by an error amplifier. In such a circuit, a high-precision circuit of bandgap reference type is typically used for the reference voltage generation circuit. The resulting error may be compared with the oscillating voltage of a triangular wave oscillator. The output of that comparison may open or close a switching circuit. Such a switching power supply circuit is typically provided in an integrated circuit.

Japanese patent application laid-open No. 2002-98375 discloses such a versatile switching power supply circuit. The power supply circuit shown in FIG. 1 of that reference is versatile, and not specially designed for the LED. It has unnecessary functions for LED lighting control. Although it is equipped with an independent oscillator so as to maintain voltage control operation irrespective of load presence or absence, the oscillator provides an unnecessary function in the case where the load is limited to the LED. Additionally, the power supply circuit shown in FIG. 1 uses the high-precision bandgap reference type reference voltage generation circuit with very high temperature dependence to maintain high-precision voltage control. However, the high-precision bandgap reference type reference voltage generation circuit is also an unnecessary function in the case where the LED is controlled. This is because even if current applied to the LED is changed by about ±20% in a high-brightness region, the human eye cannot recognize its change.

Switching power supply ICs for an LED are commercially available. However, such ICs are costly because they use high-speed switching device for miniaturization, or specialized circuit configuration for high efficiency. Thus, there exists a need for a power supply designed specifically to power an LED.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a digital power supply system including a microcontroller circuit, a driver circuit, a step down circuit, a boost circuit, and a buck and boost circuit.

The microcontroller circuit may be adapted to provide a first plurality of pulse width modulated signals and a second plurality of pulse width modulated signals and to receive a signal indicative of an input current, a signal indicative of an input voltage, a signal indicative of an output current, a signal indicative of an output voltage, and a 3.3 volt supply.

The driver circuit may be adapted to receive the first plurality of pulse width modulated signals and a 12 volt supply and to provide at least one DC power signal to a load and the signal indicative of the output current.

The driver circuit may further include at least one gate driver circuit and a corresponding operational amplifier circuit.

The at least one gate driver circuit may be adapted to receive the first plurality of pulse width modulated signals and the 12 volt supply and provide the at least one DC power signals to the load and a control signal.

The operational amplifier circuit may be adapted to receive the control signal and provide the signal indicative of the output current.

Each of the at least one gate driver circuits may include a gate driver and a transistor.

Each gate driver may be adapted to receive one of the first plurality of pulse width modulated signals and the 12 volt supply and provide a driver signal and the control signal.

Each transistor may have a gate connected to the driver signal, a source connected to the operational amplifier circuit and the control signal, and a drain adapted to provide at least one DC power signal to the load.

The operational amplifier circuit may include an operational amplifier having a positive input connected to the source of the transistor of the at least one gate driver circuit and the control signal, a negative input connected to a ground through a first resistor, and an output connected to the negative input through a second resistor and adapted to provide the signal indicative of the output current.

The step down circuit may be adapted to receive a positive input voltage and provide the 3.3 volt supply.

The step down circuit may include a transistor and a step down converter.

The transistor of the step down circuit may have a drain connected to the positive input voltage and a source connected to the negative input voltage through a capacitor.

The step down converter may be adapted to receive a supply voltage through a diode from the source of the transistor of the step down circuit and to provide the 3.3 volt supply.

The boost circuit may be adapted to receive the 3.3 volt supply and provide the 12 volt supply. The boost circuit may include a boost converter adapted to receive the 3.3 V supply and provide a 12V supply.

The buck and boost circuit may be adapted to receive the second plurality of pulse width modulated signals and provide the signal indicative of the output voltage, the signal indicative of the input current, the signal indicative of the input voltage, and the positive input voltage. The buck and boost circuit may include an AC input circuit, a buck and boost driver circuit, an input current sense circuit, and an input voltage sense circuit.

The AC input circuit may be adapted to provide the positive input voltage signal and a negative input voltage signal.

The buck and boost driver circuit may be adapted to receive the second plurality of pulse width modulated signals and the positive input voltage and provide the signal indicative of the output voltage and a load voltage signal. The buck and boost driver circuit may include a buck circuit, a boost circuit, an input current sense circuit, and an input voltage sense circuit.

The buck circuit may include a buck gate driver, a first buck transistor, and a second buck transistor.

The buck gate driver may be adapted to receive a first at least one of the second plurality of pulse width modulated signals and provide a first plurality of control signals.

The first buck transistor may have a drain connected to the positive input voltage, a gate connected to a first of the first plurality of control signals, and a source connected to a second of the first plurality of control signals.

The second buck transistor may have a drain connected to the source of the first buck transistor, a gate connected to a third of the first plurality of control signals, and a source connected to a ground.

The boost circuit may include a boost gate driver, a first boost transistor, and a second boost transistor.

The boost gate driver may be adapted to receive a second at least one of the second plurality of pulse width modulated signals and provide a second plurality of control signals.

The first boost transistor may have a drain connected to the load voltage signal, a gate connected to a first of the second plurality of control signals, and a source connected to a second of the second plurality of control signals, the source of the first buck transistor, and the drain of the second buck transistor.

The second boost transistor may have a drain connected to the source of the first boost transistor, a gate connected to a third of the second plurality of control signals, and a source connected to the ground.

The input current sense circuit may be adapted to receive the negative input voltage signal and provide the signal indicative of the input current.

The input voltage sense circuit may be adapted to receive the positive input voltage signal and provide the signal indicative of the input voltage.

The first at least one of the second plurality of pulse width modulated signals may be adapted to modify a frequency of the buck circuit.

The second at least one of the second plurality of pulse width modulated signals may be adapted to modify a frequency of the boost circuit.

The buck gate driver may include a high-side driver biased to be enabled, and a low-side driver biased to be enabled.

The boost gate driver may include a high-side driver biased to be enabled, and a low-side driver biased to be enabled.

The second plurality of pulse width modulated signals may include a first pulse width modulated high signal provided by the microcontroller and adapted to be received by the high-side driver of the buck gate driver, a first pulse width modulated low signal provided by the microcontroller and adapted to be received by the low-side driver of the buck gate driver, a second pulse width modulated high signal provided by the microcontroller and adapted to be received by the high-side driver of the boost gate driver, and a second pulse width modulated low signal provided by the microcontroller and adapted to be received by the low-side driver of the boost gate driver.

The power value of the at least one DC power signal may be dependent upon a frequency of the first plurality of pulse width modulated signals.

The at least one DC power signal may be provided at a first frequency dependent upon a second frequency of the first plurality of pulse width modulated signals.

### BRIEF DESCRIPTION OF THE DRAWINGS

FIG. 1a is a schematic diagram of a first portion of the microcontroller circuit according to an embodiment of the digital power supply.

FIG. 1b is a schematic diagram of a second portion of the microcontroller circuit according to an embodiment of the digital power supply.

FIG. 2a is a schematic diagram of a first portion of a driver circuit according to an embodiment of the digital power supply.

FIG. 2b is a schematic diagram of a second portion of a driver circuit according to an embodiment of the digital power supply.

FIG. 3 is a schematic diagram of a step down circuit according to an embodiment of the digital power supply.

FIG. 4 is a schematic diagram of a boost circuit according to an embodiment of the digital power supply.

FIG. 5 is a schematic diagram of a header circuit according to an embodiment of the digital power supply.

FIG. 6a is a schematic diagram of a first portion of a buck and boost circuit according to an embodiment of the digital power supply.

FIG. 6b is a schematic diagram of a second portion of a buck and boost circuit according to an embodiment of the digital power supply.

FIG. 6c is a schematic diagram of a third portion of a buck and boost circuit according to an embodiment of the digital power supply.

FIG. 6d is a schematic diagram of a fourth portion of a buck and boost circuit according to an embodiment of the digital power supply.

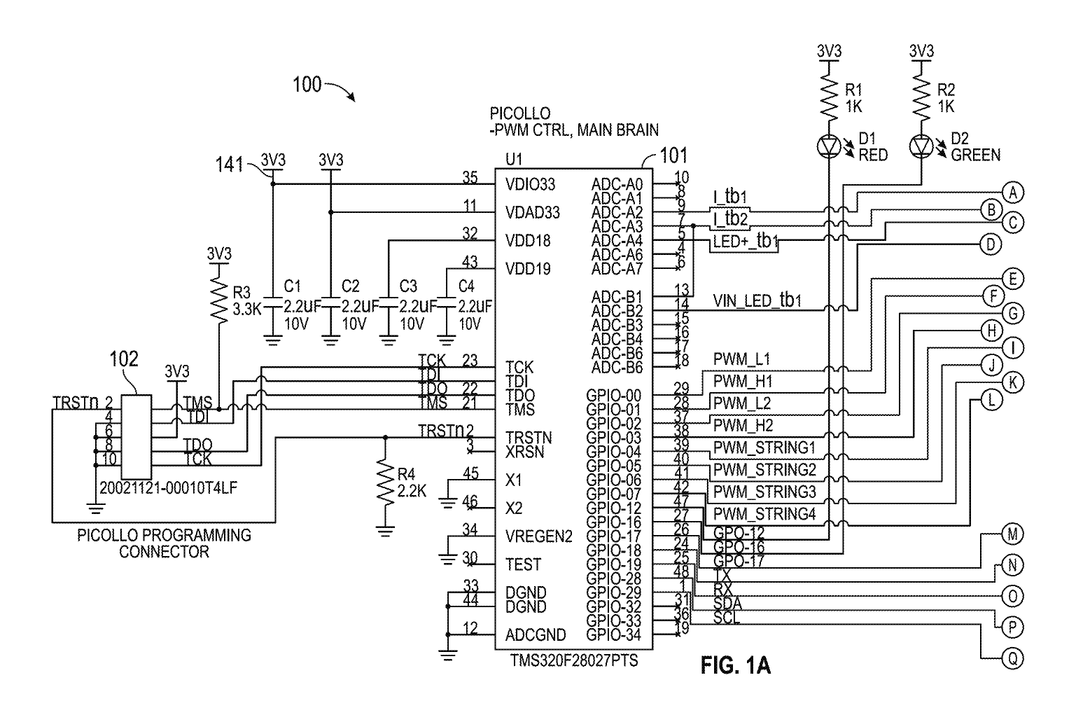

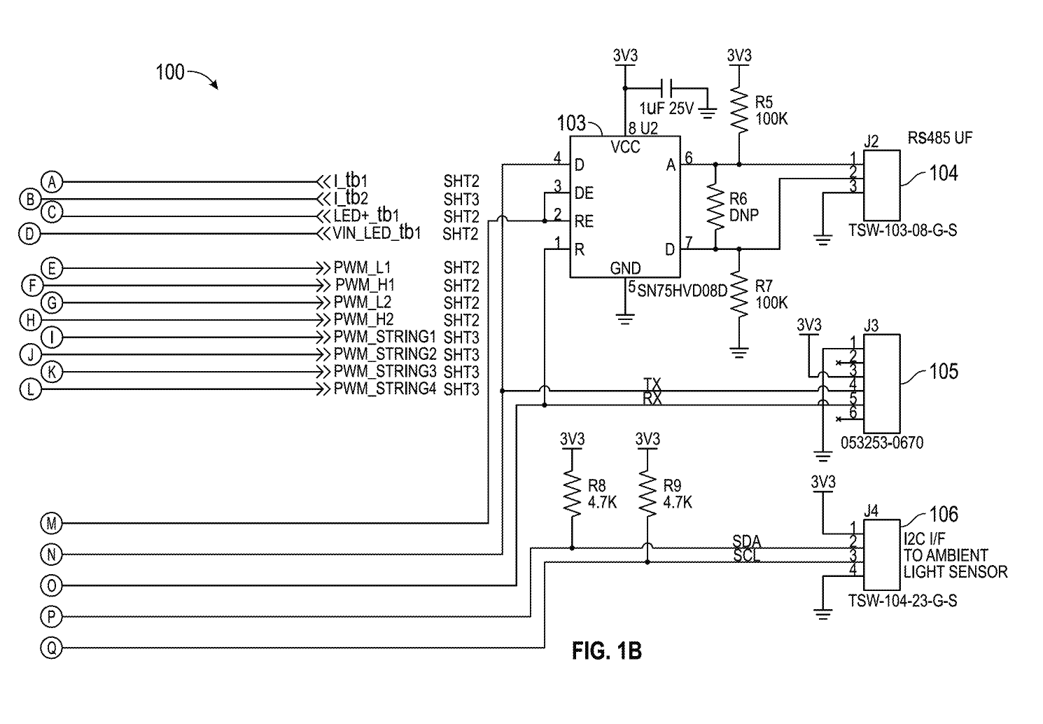

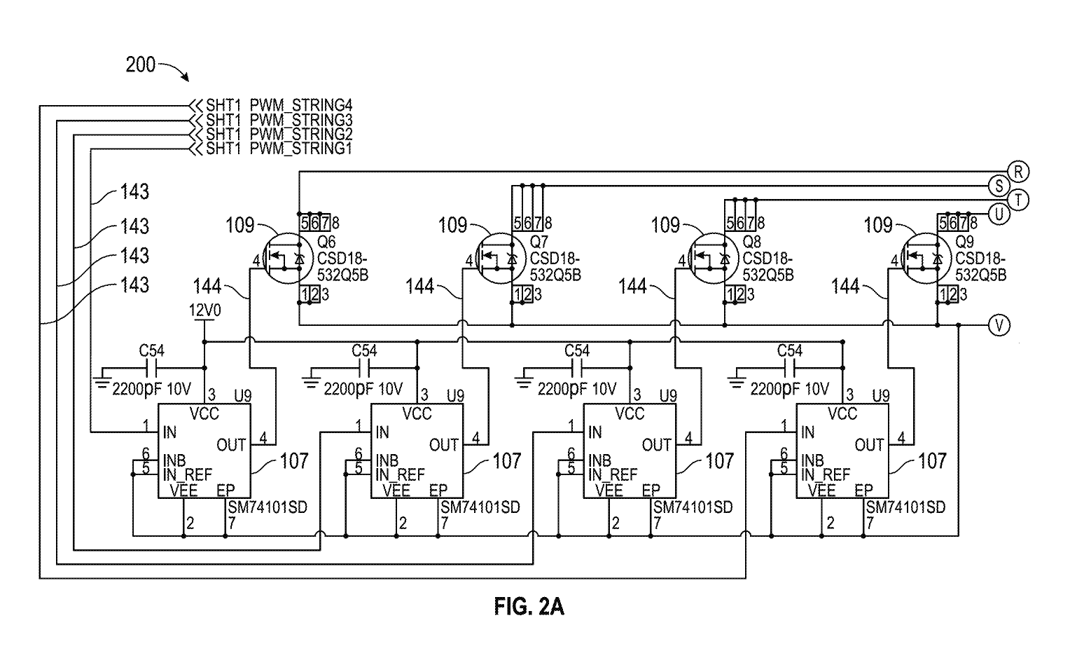

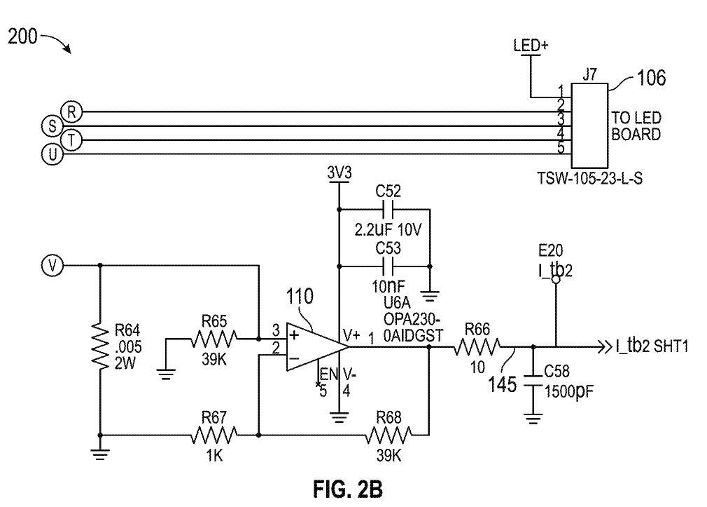

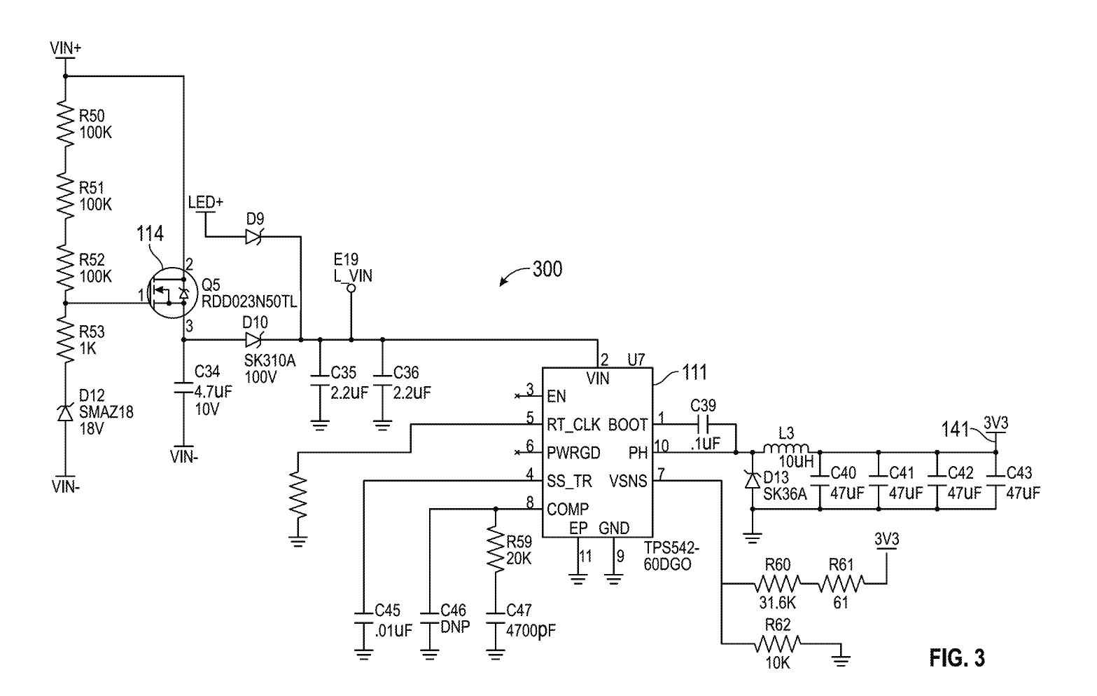

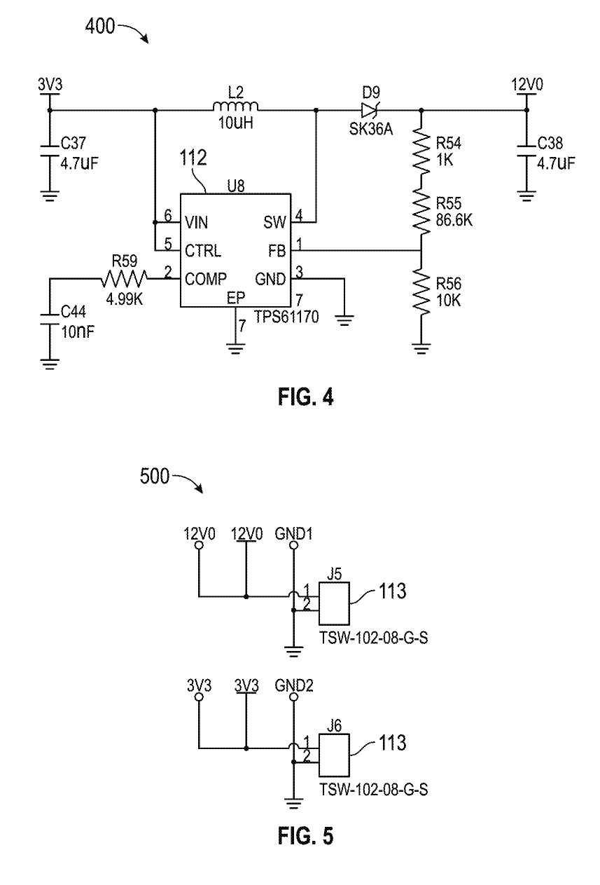

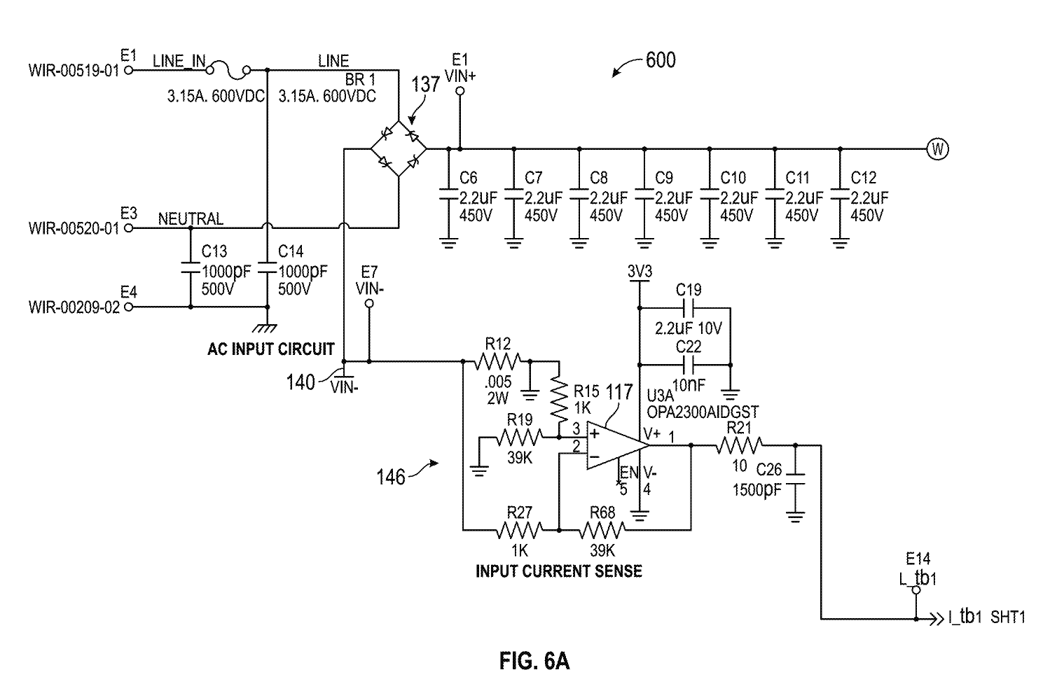

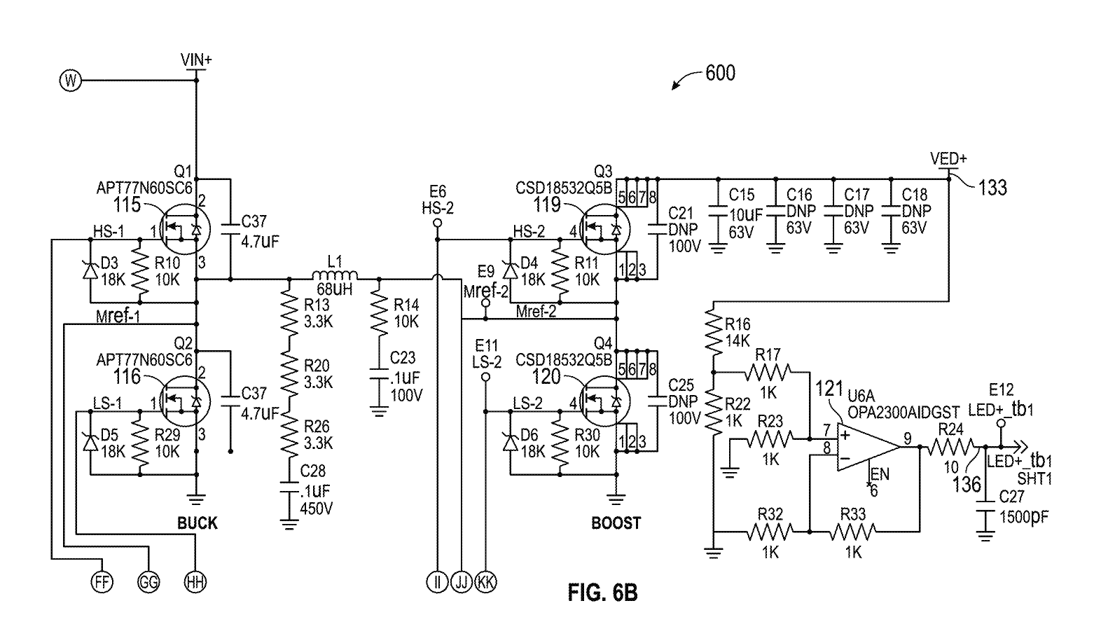

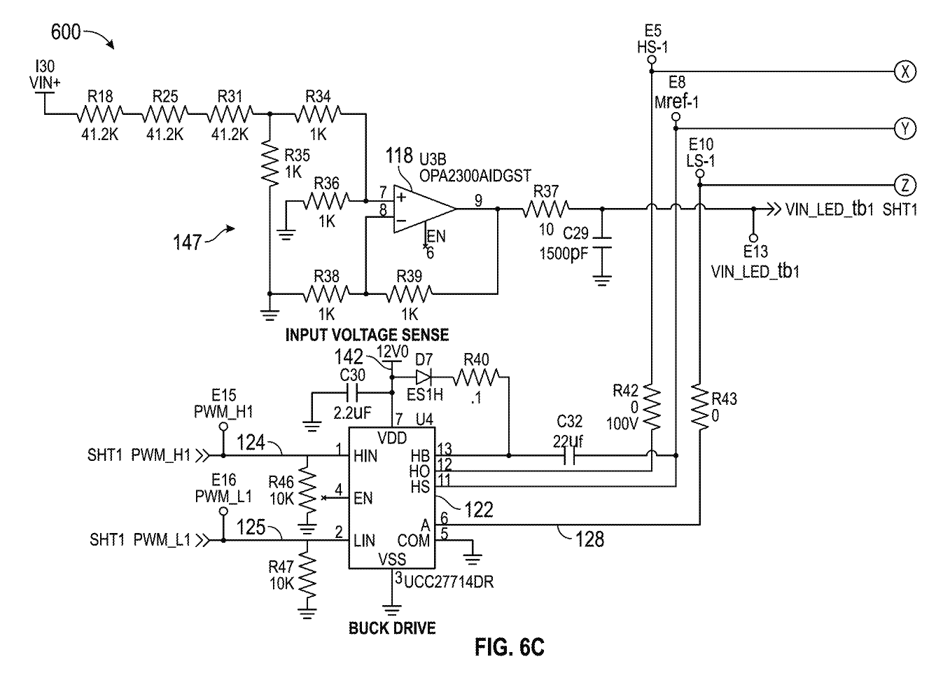

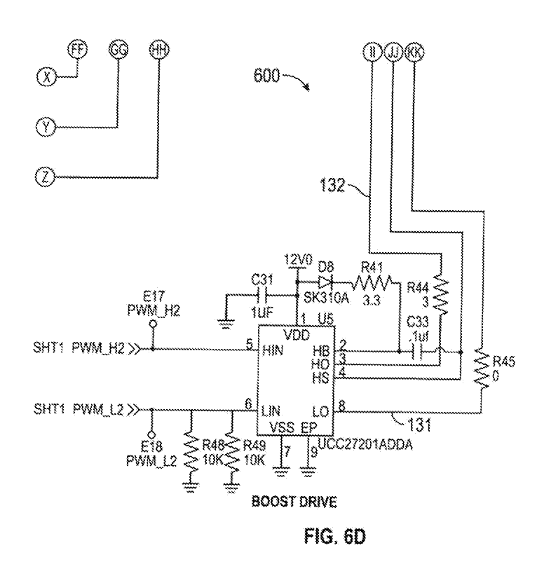

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a digital power supply 100. The digital power supply may include a microcontroller circuit 100, an LED driver circuit 200, a step down circuit 300, a boost circuit 400, a header circuit 500, and a buck and boost circuit 600. One or more of these various circuits may be implemented on a circuit board. In one embodiment, all circuits used in the digital power supply may reside on a common circuit board.

The digital power supply 100 may convert AC power to DC power. The DC power may be provided to a load. The load may be one or more LEDs. The digital power supply 100 may regulate the AC input power before the AC input power is converted to DC power. The regulation of AC power may result in periods during which no DC power is available to the load. The periods may be called dark periods. These dark periods may occur when the AC power transitions between negative and positive phases. Fast switching MOSFETs may be utilized to minimize the duration of dark periods. The duration of a dark period may be too short to be recognized by the human eye when the load is an LED.

The microcontroller circuit 100 may include a microcontroller 101, a microcontroller programming connector 102, a transceiver 103, an RS485 interface header 104, a tx/rx interface header 105, and an i²c interface header 106.

The microcontroller programming connector 102 may have TMS, TDI, TDO, TRST, and TCK signals electrically connected to corresponding TMS, TDI, TDO, TRST, and TCK signals on the microcontroller 101. The set of TMS, TDI, TDO, TRST, and TCK signals may implement a JTAG standard, IEEE standard 1149.1, used to program the microcontroller 101. The microcontroller programming connector 102 may also provide a connection to voltage and ground signals located on the circuit board.

The microcontroller circuit 100 may include a transceiver 103. The transceiver 103 may be an RS-485 transceiver. The transceiver 103 may be implemented by a Texas Instruments SNx5HVD08 device. The transceiver 103 may receive control signals from the microcontroller 101 and an RS485 interface. The transceiver 103 may transmit information provided from the microcontroller 101 or provide information to the microcontroller 101 depending upon the control signals. In one embodiment, the transceiver 103 may implement an RS485 protocol.

The microcontroller circuit 100 may have a microcontroller 101. The microcontroller may be implemented by a Texas Instruments TMS320F28027 device. The microcontroller 101 may be programmed to use a feedback loop to regulate current through a load. The load may be a string of LEDs. The current provided to the load may be regulated by the microcontroller 101. Current regulation may be implemented by creating an output signal to modify the duty cycle of a full bridge. This duty cycle adjustment may provide the appropriate amount of current through an inductor L1 in the buck and boost circuit 600. The current regulation may enable the full bridge to operate in boost mode when the input voltage is less than the output voltage. The current regulation may enable the full bridge to run in buck mode when the input voltage is greater than the output voltage. The microcontroller 101 may receive input signals indicating the input voltage, input current, output voltage, and output current. These signals may be the VIN_LED_tb1 134, I_tb1 135, LED+_tb1 136, and I_tb2_SHT1 145 signals, respectively.

The microcontroller 101 may receive the value of the output current as an input to allow the microcontroller 101 to calculate the appropriate duty cycle for a given mode of operation, including buck and boost modes. The microcontroller 101 may receive the value of the input and output voltages as input signals, which may enable the microcontroller 101 to select the appropriate operating mode, including buck and boost modes. Such a configuration may allow the digital power supply 100 to quickly determine the appropriate mode of operation and quickly calculate and output one or more appropriate control signals to adjust the duty cycle for the bridge in response to the rapidly changing input voltage. This operation may maintain a near constant output current to the load. The output current may be near constant even in cases when the output current is zero, or near zero, for a portion of a duty cycle.

The microcontroller circuit 100 may include a plurality of headers. A tx/rx interface header 105 may connect to tx and rx signals. The tx/rx interface header 105 may also connect to a 3.3 voltage supply 141 and to ground. An I²C interface header 106 may connect to a 3.3 voltage supply 141, ground, and the signals implementing an I²C protocol. An RS485 interface header 104 may connect to ground and to signals implementing an RS485 interface. The header contacts may provide signals for testing, monitoring, diagnostic, and troubleshooting.

The buck and boost circuit 600 may include a buck and boost driver circuit. The buck and boost driver circuit may include a buck gate driver 122, a boost gate driver 123, a first buck transistor 116, a second buck transistor 115, a first boost transistor 120, and a second boost transistor 119. The buck and boost driver circuit may receive a first pulse width modulated high signal 124, a first pulse width modulated low signal 125, a second pulse width modulated high signal 126, and a second pulse width modulated low signal 127 from the microcontroller 101. The first pulse width modulated high signal 124 may be input to a high-side driver input on the buck gate driver 122. The first pulse width modulated low signal 125 may be input to a low-side driver input on the buck gate driver 122. The buck gate driver 122 may be biased to always be enabled. The buck gate driver 122 may be a high-side and low-side driver. The typical high threshold for the buck gate driver 122 may be 2.3 V and the typical low threshold may be 1.6 V. The buck gate driver 122 may be implemented by a Texas Instrument UTC27714 device or the like. A low-side driver output 128 may be output by the buck gate driver 122 and input to a gate of a first buck transistor 116. The low-side driver output 128 may be high when the first pulse width modulated low signal 125 is high. A high-side driver output 129 may be output by the buck gate driver 122 and input to a gate of a second buck transistor 115. The high-side driver output 129 may be high when the first pulse width modulated high signal 124 is high.

The first buck transistor 116 and the second buck transistor 115 may be implemented by Microsemi APT77N60SC6 devices. The drain side of the second buck transistor 115 may be connected to the input voltage 130 of the buck and boost circuit 600. The supply side of the second buck transistor 115 may be connected to the drain side of the first buck transistor 115. The supply side of the first buck transistor 115 may be connected to ground. Those skilled in the art will recognize appropriate biasing resistors, capacitors, and diodes may also be connected to the first buck transistor 116 and the second buck transistor 115.

A second pulse width modulated high signal 126 may be input to the high-side of a boost gate driver 123. A second pulse width modulated low signal 127 may be input to the low-side input of the boost gate driver 123. The boost gate driver 123 may be biased to always be enabled. The boost gate driver 123 may be a high-side and low-side driver. The typical high threshold for the gate driver 123 may be the same or similar as the typical high threshold for the buck gate driver 123. The typical low threshold for the boost gate driver 123 may be the same as or similar to the low threshold for the buck gate driver 122. The boost gate driver 123 may be implemented by a Texas Instruments UCC27201 device, or the like. A second low-side driver output 131 may be output by the boost gate driver 123 and input to a gate of a first boost transistor 120. The second low-side driver output 131 may be high when the second pulse width modulated low signal 127 is high. A second high-side driver output 132 may be output by the boost gate driver 123 and input to a gate of a second boost transistor 119. The second high-side driver output 132 may be high when the second pulse width modulated high signal 126 is high.

The first boost transistor 120 and the second boost transistor 119 may each be implemented by Texas Instruments CSD18532Q5B devices. The drain side of the second boost transistor 119 may be connected to the LED voltage 133 of the buck and boost circuit 600, which may be a load voltage. The supply side of the second boost transistor 119 may be connected to the drain side of the first boost transistor 120. The supply side of the first boost transistor 120 may be connected to ground. Those skilled in the art will recognize appropriate biasing resistors, capacitors, and diodes may also be connected to the first boost transistor 120 and the second boost transistor 119. The connection between the source of the second buck transistor 115 and the drain of the first buck transistor 116 may be inductively coupled to the connection between the source of the second boost transistor 119 and the drain of the first boost transistor 120.

The LED voltage 133 of the buck and boost circuit 600 may be connected to a positive side of an operational amplifier 121 through a 14 kΩ resistor R16 in series with a 1 kΩ resistor R17, which has one end tied directly to the positive input of the op amp 121 and the other side connected to one end of a 1 kΩ resistor R22, which has its other end connected to ground. An additional 1 kΩ resistor R23 may be connected directly to the positive side of the op amp 121 and the other end of resistor R23 may be directly connected to ground. The negative input to the op amp 121 may be connected to ground through a 1 kΩ resistor R32 and also connected to the output of the op amp 121 through a 1 kΩ resistor R33. The output of the op amp 121 may pass through a 10Ω resistor and be output from the buck and boost circuit 600 as LED+_tb1 136, which may be an input to the microcontroller circuit 100.

The buck and boost circuit 600 may include an input voltage sense circuit 147. The input voltage sense circuit may an operational amplifier (op amp) 118. The op amp 118 may have a positive input connected to the input voltage 130 of the buck and boost circuit 600 through a 1 k resistor R34, with one side directly connected to the first op amp 118 positive input and the other side connected to the first of three 41.2 kΩ resistors R31, R25, and R16, which are placed in series. A 1 kΩ resistor R35 may have one side connected to ground and the other side connected to the circuit between R34 and a first 41.2 kΩ resistor R31. The positive input of the first op amp 118 may also connect to ground through a 1 kΩ resistor R36. The negative input to the first op amp may be connected to ground through a 1 kΩ resistor R38. The negative input of the first op amp 118 may be connected to the output of the first op amp 118 through a 1 kΩ resistor R39. The output of the first op amp 118 may pass through a 10Ω resistor R37, then be output from the buck and boost circuit as VIN_LED_tb1 134, which may be a signal indicative of the input voltage and provided as an input to the microcontroller circuit 100.

The buck and boost circuit 600 may include an input current sense circuit. The input current sense circuit 146 may an op amp 117. The op amp 117 may have a positive input connected to a negative input voltage 140 of the buck and boost circuit 600 through a 1 k resistor R15 directly connected to the positive input, in series with a 0.005 ohm, 2 W resistor R12. The positive input of the op amp 117 may be connected to ground through a 39 kΩ resistor R19. A negative input of the op amp 117 may be connected to the negative input voltage 140 of the buck and boost circuit 600 through a 1 kΩ resistor R27. The negative input of the op amp 117 may be connected to the output of the op amp 117 through a 39 kΩ resistor R28. The output of the second op amp 117 may pass through a 10Ω resistor R21, then be output from the buck and boost circuit as I_tb1 135, which may be a signal indicative of the input current and provided as an input to the microcontroller circuit 100. The first op amp 118 and the second op amp 117 may be implemented by a Texas Instruments OPA2300 device.

The buck and boost circuit 600 may include an AC input circuit. The AC input circuit may receive an AC signal, which may be connected to a bridge rectifier 137, which may provide an input voltage 130 and a negative input voltage 140.

The step down circuit 300 may include a transistor 114 and a step down converter 111. The transistor 114 may be configured with an input voltage 130 connected to the drain. The input voltage 130 may be connected to three resistors in series, R50, R51, R52, with the last resistor in the series connected to the gate of the transistor 114. The combined resistance of resistors R50, R51, and R52 may be 300 kΩ. Each of the resistors R50, R51, and R52 may be 100 kΩ. The transistor 114 may also be connected through a resistor R53 and a diode D12 to negative input voltage 140. Resistor R53 may be a 1 kΩ resistor. The source of transistor 114 may be connected through a diode to the input voltage of the step down converter 111. Decoupling capacitors may also be connected to the input voltage of the step down converter 111. The step down converter 111 may be implemented with a Texas Instruments TPS 54260 device. The switching frequency of the step down converter 111 may be set to between 275 kHz and 310 kHz. In one embodiment, the switching frequency may be 300 kHz. The switching frequency may be set by connecting a 412 kΩ resistor R56 to the resistor timing input of the step down converter 111. The step down converter 111 may be configured to always be enabled. Step down converter 111 may output a signal which may pass through an inductor and then be used as a 3.3 voltage supply 141.

A boost circuit 400 may have a boost converter 112. The boost converter 112 may receive a 3.3 voltage supply 141 as the input voltage. This switching node of the boost converter 112 may be connected through a diode to a 12V power supply 142. The switching node of the boost converter 112 may also be connected through an inductor L2 to the 3.3 voltage supply 141.

An LED driver circuit 200 may have one or more gate driver circuits, which each provide a power signal to an LED or other load. In addition, the LED driver circuit 200 may have an op amp circuit which may provide at least one input to the microcontroller circuit 100. The LED driver circuit 200 may have a plurality of gate drivers 107. Each of the plurality of gate drivers 107 may be connected to a different PWM_string signal 143 output by the microcontroller circuit 100. The PWM_string signal 143 may be input to a gate driver 107. The gate driver 107 may output a driver signal 144 relative to the PWM_string signal 143 input to the gate driver 107. The gate driver 107 output driver signal 144 may be capable of sourcing up to 3 A or sinking up to 7 A. The driver signal 144 may be connected to the gate of a transistor 109. The transistor 109 drain may be connected through a 0.005Ω, 2 W resistor R64 to ground and through a 1 kΩ resistor R63 to the positive input of an op amp 110. The transistor 109 source may be connected to an LED or other load, or to a header 108, which may be in electrical communication with an LED or other load.

The positive input of op amp 110 may be connected to ground through a 39 kΩ resistor R65. The negative input of op amp 110 may be connected to ground through a 1 kΩ resistor R67. The output the op amp 110 may be fed back to the negative input of the op amp through a 39 kΩ resistor R68. The output of the op amp 110 may pass through a 10Ω resistor R66 and be provided to the microcontroller circuit 100 as I_tb2_SHT1 145.

One or more header circuits 500 may be used in a header circuit 500, a header 113 may be connected to one or more signals implementing the digital power supply 100. The contacts on the header 113 may be used for test, diagnosis, or troubleshooting.

Those skilled in the art will appreciate that appropriate biasing resistors or conditioning circuitry may be included in or connected to any trace within the digital power supply 100. Specific implementations of circuitry within the disclosure of the specification may require resistors, capacitors, or the like of appropriate values, the determination of which is within the knowledge of one skilled in the art.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

That which is claimed is:

1. A digital power supply system comprising:
a microcontroller circuit adapted to provide a first plurality of pulse width modulated signals and a second plurality of pulse width modulated signals and to receive a signal indicative of an input current, a signal indicative of an input voltage, a signal indicative of an output current, a signal indicative of an output voltage, and a 3.3 volt supply;
a driver circuit adapted to receive the first plurality of pulse width modulated signals and a 12 volt supply and provide at least one DC power signal to a load and the signal indicative of the output current;
a step down circuit adapted to receive a positive input voltage and provide the 3.3 volt supply;
a boost circuit adapted to receive the 3.3 volt supply and provide the 12 volt supply; and
a buck and boost circuit adapted to receive the second plurality of pulse width modulated signals and provide the signal indicative of the output voltage, the signal indicative of the input current, the signal indicative of the input voltage, and the positive input voltage.

2. The system according to claim 1 wherein a power value of the at least one DC power signal is dependent upon a frequency of the first plurality of pulse width modulated signals.

3. The system according to claim 1 wherein the at least one DC power signal is provided at a frequency.

4. The system according to claim 3 wherein the frequency of the at least one DC power signal is dependent upon a second frequency of the first plurality of pulse width modulated signals.

5. The system according to claim 1 wherein the buck and boost circuit comprises:
an AC input circuit adapted to provide the positive input voltage signal and a negative input voltage signal;
a buck and boost driver circuit adapted to receive the second plurality of pulse width modulated signals and the positive input voltage and provide the signal indicative of the output voltage and a load voltage signal;
an input current sense circuit adapted to receive the negative input voltage signal and provide the signal indicative of the input current; and
an input voltage sense circuit adapted to receive the positive input voltage signal and provide the signal indicative of the input voltage.

6. The system according to claim 5 wherein the step down circuit comprises:
a transistor having a drain connected to the positive input voltage and a source connected to the negative input voltage through a capacitor; and
a step down converter adapted to receive a supply voltage through a diode from the source of the transistor and to provide the 3.3 volt supply.

7. The system according to claim 5 wherein the buck and boost driver circuit comprises:
a buck circuit comprising:
a buck gate driver adapted to receive a first at least one of the second plurality of pulse width modulated signals and provide a first plurality of control signals,
a first buck transistor having a drain connected to the positive input voltage, a gate connected to a first of the first plurality of control signals, and a source connected to a second of the first plurality of control signals, and
a second buck transistor having a drain connected to the source of the first buck transistor, a gate connected to a third of the first plurality of control signals, and a source connected to a ground;
a boost circuit comprising:
a boost gate driver adapted to receive a second at least one of the second plurality of pulse width modulated signals and provide a second plurality of control signals,
a first boost transistor having a drain connected to the load voltage signal, a gate connected to a first of the second plurality of control signals, and a source connected to a second of the second plurality of control signals, the source of the first buck transistor, and the drain of the second buck transistor, and
a second boost transistor having a drain connected to the source of the first boost transistor, a gate connected to a third of the second plurality of control signals, and a source connected to the ground.

8. The system according to claim 7 wherein the first at least one of the second plurality of pulse width modulated signals is adapted to modify a frequency of the buck circuit.

9. The system according to claim 7 wherein the second at least one of the second plurality of pulse width modulated signals is adapted to modify a frequency of the boost circuit.

10. The system according to claim 7 wherein
the buck gate driver comprises:
a high-side driver biased to be enabled, and
a low-side driver biased to be enabled;
wherein the boost gate driver comprises:
a high-side driver biased to be enabled, and
a low-side driver biased to be enabled.

11. The system according to claim 10 wherein the second plurality of pulse width modulated signals further comprise:
a first pulse width modulated high signal provided by the microcontroller and adapted to be received by the high-side driver of the buck gate driver;
a first pulse width modulated low signal provided by the microcontroller and adapted to be received by the low-side driver of the buck gate driver;
a second pulse width modulated high signal provided by the microcontroller and adapted to be received by the high-side driver of the boost gate driver; and
a second pulse width modulated low signal provided by the microcontroller and adapted to be received by the low-side driver of the boost gate driver.

12. The system according to claim 1 wherein the driver circuit further comprises:
at least one gate driver circuit adapted to receive the first plurality of pulse width modulated signals and the 12 volt supply and provide the at least one DC power signals to the load and a control signal; and
an operational amplifier circuit adapted to receive the control signal and provide the signal indicative of the output current.

13. The system according to claim 12 wherein each of the at least one gate driver circuits further comprises:
a gate driver adapted to receive one of the first plurality of pulse width modulated signals and the 12 volt supply and provide a driver signal and the control signal;
a transistor having a gate connected to the driver signal, a source connected to the operational amplifier circuit and the control signal, and a drain adapted to provide at least one DC power signal to the load.

14. The system according to claim 13 wherein the operational amplifier circuit further comprises:
an operational amplifier having a positive input connected to the source of the transistor of the at least one gate driver circuit and the control signal, a negative input connected to a ground through a first resistor, and an output connected to the negative input through a second resistor and adapted to provide the signal indicative of the output current.

15. The system according to claim 1 wherein the boost circuit comprises a boost converter adapted to receive the 3.3 V supply and provide a 12V supply.

16. A digital power supply system comprising:
a microcontroller circuit adapted to provide a first plurality of pulse width modulated signals and a second plurality of pulse width modulated signals and to receive a signal indicative of an input current, a signal indicative of an input voltage, a signal indicative of an output current, a signal indicative of an output voltage, and a 3.3 volt supply;
a driver circuit adapted to receive the first plurality of pulse width modulated signals and a 12 volt supply and provide at least one DC power signal to a load and the signal indicative of the output current;
a step down circuit adapted to receive a positive input voltage and provide the 3.3 volt supply;
a boost circuit adapted to receive the 3.3 volt supply and provide the 12 volt supply;
a buck and boost circuit adapted to receive the second plurality of pulse width modulated signals and provide the signal indicative of the output voltage, the signal indicative of the input current, the signal indicative of the input voltage, and the positive input voltage; and
wherein the at least one DC power signal is provided at a first frequency dependent upon a second frequency of the first plurality of pulse width modulated signals.

17. The system according to claim 16 wherein the buck and boost circuit comprises:
an AC input circuit adapted to provide the positive input voltage signal and a negative input voltage signal;
a buck and boost driver circuit comprising:
a buck circuit comprising:
a buck gate driver adapted to receive a first at least one of the second plurality of pulse width modulated signals and provide a first plurality of control signals and comprising:
a first high-side driver biased to be enabled, and
a first low-side driver biased to be enabled,
a first buck transistor having a drain connected to the positive input voltage, a gate connected to a first of the first plurality of control signals, and a source connected to a second of the first plurality of control signals, and
a second buck transistor having a drain connected to the source of the first buck transistor, a gate connected to a third of the first plurality of control signals, and a source connected to a ground;
a boost circuit comprising:
a boost gate driver adapted to receive a second at least one of the second plurality of pulse width modulated signals and provide a second plurality of control signals and comprising:
a second high-side driver biased to be enabled, and
a second low-side driver biased to be enabled,
a first boost transistor having a drain connected to the load voltage signal, a gate connected to a first of the second plurality of control signals, and a source connected to a second of the second plurality of control signals, the source of the first buck transistor, and the drain of the second buck transistor, and
a second boost transistor having a drain connected to the source of the first boost transistor, a gate connected to a third of the second plurality of control signals, and a source connected to the ground;
an input current sense circuit adapted to receive the negative input voltage signal and provide the signal indicative of the input current; and
an input voltage sense circuit adapted to receive the positive input voltage signal and provide the signal indicative of the input voltage.

18. The system according to claim 16 wherein the step down circuit comprises:
a transistor having a drain connected to the positive input voltage and a source connected to the negative input voltage through a capacitor; and
a step down converter adapted to receive a supply voltage through a diode from the source of the transistor and to provide the 3.3 volt supply.

19. The system according to claim 16 wherein the driver circuit comprises:
at least one gate driver circuit comprising:
a gate driver adapted to receive one of the first plurality of pulse width modulated signals and the 12 volt supply and provide a driver signal and a control signal;
a transistor having a gate connected to the driver signal, a source, and the control signal, and a drain adapted to provide the at least one DC power signal to the load; and
an operational amplifier having a positive input connected to the source of the transistor of the at least one gate driver circuit and the control signal, a negative input connected to the ground through a first resistor, and an output connected to the negative input through a second resistor and adapted to provide the signal indicative of the output current.

20. A digital power supply system comprising:
a microcontroller circuit adapted to provide a first plurality of pulse width modulated signals and a second plurality of pulse width modulated signals and to receive a signal indicative of an input current, a signal indicative of an input voltage, a signal indicative of an output current, a signal indicative of an output voltage, and a 3.3 volt supply;
a driver circuit comprising:
at least one gate driver circuit comprising:
a gate driver adapted to receive one of the first plurality of pulse width modulated signals and the 12 volt supply and provide a driver signal and a control signal,
a first transistor having a gate connected to the driver signal, a source, and the control signal, and a drain adapted to provide the at least one DC power signal to the load, and
an operational amplifier having a positive input connected to the source of the first transistor of the at least one gate driver circuit and the control signal, a negative input connected to a ground through a first resistor, and an output connected to the negative input through a second resistor and adapted to provide the signal indicative of the output current;
a step down circuit comprising:
a second transistor having a drain connected to a positive input voltage and a source connected to a negative input voltage through a capacitor, and
a step down converter adapted to receive a supply voltage through a diode from the source of the second transistor and to provide the 3.3 volt supply;
a boost circuit comprising a boost converter adapted to receive the 3.3 V supply and provide a 12V supply; and
a buck and boost circuit comprising:
an AC input circuit adapted to provide the positive input voltage signal and the negative input voltage signal;
a buck and boost driver circuit comprising:
a buck circuit comprising:
a buck gate driver adapted to receive a first at least one of the second plurality of pulse width modulated signals and provide a first plurality of control signals and comprising:
a first high-side driver biased to be enabled, and
a first low-side driver biased to be enabled,
a first buck transistor having a drain connected to the positive input voltage, a gate connected to a first of the first plurality of control signals, and a source connected to a second of the first plurality of control signals, and
a second buck transistor having a drain connected to the source of the first bust transistor, a gate connected to a third of the first plurality of control signals, and a source connected to the ground;
a boost circuit comprising:
a boost gate driver adapted to receive a second at least one of the second plurality of pulse width modulated signals and provide a second plurality of control signals and comprising:
a second high-side driver biased to be enabled, and
a second low-side driver biased to be enabled,
a first boost transistor having a drain connected to the load voltage signal, a gate connected to a first of the second plurality of control signals, and a source connected to a second of the second plurality of control signals, the source of the first buck transistor, and the drain of the second buck transistor, and
a second boost transistor having a drain connected to the source of the first boost transistor, a gate connected to a third of the second plurality of control signals, and a source connected to the ground;
an input current sense circuit adapted to receive the negative input voltage signal and provide the signal indicative of the input current, and
an input voltage sense circuit adapted to receive the positive input voltage signal and provide the signal indicative of the input voltage.
